(19) United States
(12) Patent Application Publication
(10) Pub. No.: US 2026/0041597 A1
(43) Pub. Date: Feb. 12, 2026

(54) Seesaw visually impaired guidance cane

(71) Applicant: Jack Bermash, Philadelphia, PA (US)

(72) Inventor: Jack Bermash, Philadelphia, PA (US)

(21) Appl. No.: 18/831,761

(22) Filed: Aug. 11, 2025

(51) Int. Cl. A61H 3/06

(52) U.S. Cl. CPC A61H 3/068; A61H 3/061; A61H 2201/5092

(57) ABSTRACT

A visually impaired person uses a guidance cane on a daily basis to judge the distance between objects or people in an effort to avoid contact or deter from bodily harm. With the usage of artificial intelligence by and through a 1 inch by 1 inch camera located on the front of the guidance cane the visually impaired person now can be informed in real time of objects of persons within their path to more effectively avoid contact and deter from bodily harm. The information gathered from the 1 inch by 1 inch camera is relayed in real time to the visually impaired person either through a wired connection or a wireless connection.

### CROSS-REFERENCE TO RELATED APPLICATION

There is no cross reference to related application.

### STATEMENT OF FEDERALLY SPONSORED RESEARCH OR DEVELOPMENT

There is no federally sponsored research or development to related application

### BACKGROUND ON THE INVENTION

The background on the invention is an updated and improved use of a visually impaired cane (also commonly referred to as a white cane) used for mobility on a daily basis by persons afflicted with sight impairment.

### BRIEF SUMMARY OF THE INVENTION

The SeeSaw Visually Impaired Guidance Cane is equipped with an artificial intelligence camera no larger than 1 inch by 1 inch secured to the front of the cane which relays surroundings information in real time to the visually impaired user.

### BRIEF DESCRIPTION OF VIEWS OF THE DRAWING

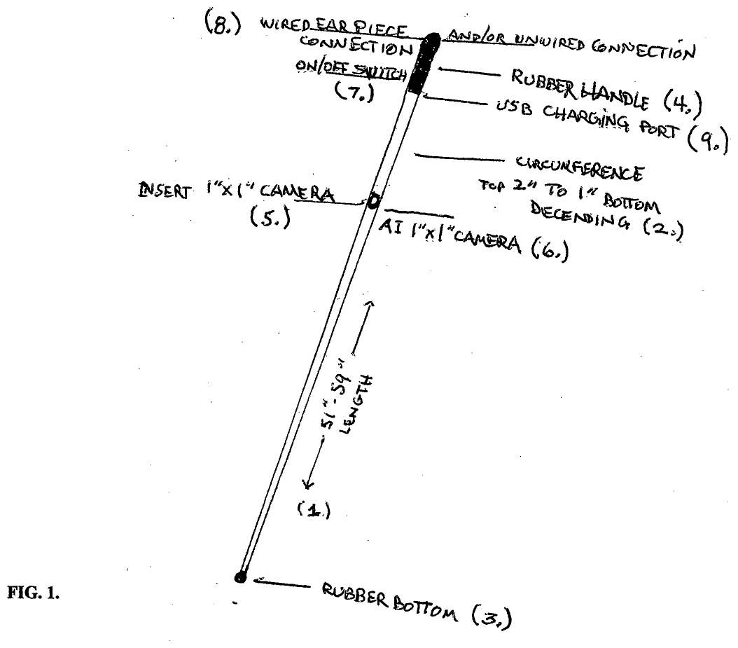

The Drawing, listed as FIG. 1., details the cane material (1), the cane length (2), the cane circumference (3), the cane's bottom (4) and top rubber attachments (5) secured for durability and insertion point of the 1 inch by 1 inch (6) artificial intelligence camera, On/off switch (7), wired or non-wired ear piece (8) and USB charging port (9).

### DETAILED DESCRIPTION OF THE INVENTION

The SeeSaw Visually Impaired Guidance Cane is manufactured from recycled material including but not limited to plastics or carbon fiber which will maintain a durable and long life usage. The visually impaired user will activate from the on/off switch the SeeSaw Visually Impaired Guidance Cane will automatically inform the user of exactly what is in front of him or her and how far away. The SeeSaw Visually Impaired Guidance Cane artificial intelligence may also be programmed with facial recognition to inform the user of family or acquaintances who come into view. The wired or unwired ear piece is part of the 1 inch by 1 inch camera and will silently inform the user of activity as seen by the SeeSaw Visually Impaired Guidance Cane.

This is the precise invention which a patent is requested, it is distinguished from any other type of visually impaired cane as they do not incorporate artificial intelligence as a guidance system for usage. The SeeSaw Visually Impaired Guidance Cane is an improvement to an existing guidance cane through the use of artificial intelligence.

1. I, Jack Barmash, claim the invention known as The SeeSaw Visually Impaired Guidance Cane.
